(19) United States
(12) Patent Application Publication
(10) Pub. No.: US 2004/0065281 A1
(43) Pub. Date: Apr. 8, 2004

(54) Two-stroke engine transfer ports

(75) Inventors: John D. Sheldon, Anderson, SC (US); Nagesh S. Mavinahally, Anderson, SC (US)

Correspondence Address: HARRINGTON & SMITH, LLP, 4 RESEARCH DRIVE, SHELTON, CT, 06484-6212, US

(73) Assignee: Homelite Technologies Ltd.

(21) Appl. No.: 10/452,079

(22) Filed: May 30, 2003

Related U.S. Application Data
(63) Continuation-in-part of application No. 10/264,939, filed on Oct. 4, 2002.

(51) Int. Cl. F02B 33/04

(52) U.S. Cl. 123/73 PP

(57) ABSTRACT

A two-stroke internal combustion engine including a cylinder; and a piston movably mounted in the cylinder. The cylinder includes an exhaust port and transfer ports. The transfer ports include a first pair of the transfer ports disposed closer to the exhaust port than a second pair of the transfer ports which are disposed further away from the exhaust port. The first pair of transfer ports are angled relative to each other at a first angle of about 70 degrees to about 85 degrees and the second pair of transfer ports are angled relative to each other at a second angle of about 120 degrees to about 150 degrees. Directional discharge of scavenged charge out of the transfer ports establishes a flow path for the scavenged charge to minimize losses of fresh unburned fuel into the exhaust port.

### CROSS-REFERENCE TO RELATED APPLICATION

This is a continuation-in-part of U.S. patent application Ser. No. 10/264,939 filed Oct. 4, 2002.

### BACKGROUND OF THE INVENTION

1. Field of the Invention

The present invention relates to internal combustion engines and, more particularly, to a transfer system.

2. Brief Description of Prior Developments

U.S. Pat. No. 6,367,432 discloses a two-stroke cycle internal combustion engine which has a quaternary Schnurle-type scavenging system that is configured such that the capacity of a pair of second scavenging passageways are made larger than the capacity of a pair of first scavenging passageways, so that during the descending stroke of the piston, air is allowed to be introduced into the combustion actuating chamber from the second scavenging passageways prior to the introduction of the air-fuel mixture and at the same time, a relatively large quantity of air is allowed to be introduced into the combustion actuating chamber from the first scavenging passageways over a longer period of time as compared with the period of time in which air is introduced from the second scavenging passageways.

U.S. Pat. No. 6,223,705 discloses a two-stroke internal combustion engine having a Schnurle scavenging system includes a pair of first scavenging ports and a pair of second scavenging ports. An inner horizontal scavenging angle formed close to an exhaust port and an outer horizontal scavenging angle formed remote from the exhaust port by a pair of scavenging flows blown out of the pair of the first scavenging ports are both set to an angle in the range of from 116 to 124 degrees. An inner horizontal scavenging angle formed close to the exhaust port and an outer horizontal scavenging angle formed remote from the exhaust port by a pair of scavenging flows blown out of the pair of the second scavenging ports are set to angles in the ranges of from 126 to 134 degrees and from 146 to 154 degrees, respectively.

Because of increasing government pollution emissions standards, there is a continuing need to lower engine emissions in two-stroke engines. One of the sources of emission problems has been the discharge of unburned hydrocarbons due to short circuiting of fuel out of an exhaust port during an upward stroke of the piston before the exhaust port is closed. Thus, there is a need to minimize the loss of fresh, short circuit fuel exiting out of the exhaust. This minimization can result in lower hydrocarbon emissions and higher fuel economy.

### SUMMARY OF THE INVENTION

In accordance with one aspect of the present invention, a two-stroke internal combustion engine is provided including a cylinder; and a piston movably mounted in the cylinder. The cylinder includes an exhaust port and transfer ports. The transfer ports include a first pair of the transfer ports disposed closer to the exhaust port than a second pair of the transfer ports which are disposed further away from the exhaust port. The first pair of transfer ports are angled relative to each other at a first angle of about 70 degrees to about 85 degrees and the second pair of transfer ports are angled relative to each other at a second angle of about 120 degrees to about 150 degrees. Directional discharge of scavenged charge out of the transfer ports establishes a flow path for the scavenged charge to minimize losses of fresh unburned fuel into the exhaust port.

In accordance with another aspect of the present invention, a two-stroke internal combustion engine is provided comprising a cylinder; and a piston movably mounted in the cylinder. The cylinder comprises an exhaust port and transfer ports. Two of the transfer ports comprise a common bottom channel extending into a side wall of the cylinder in a bottom portion of the cylinder and separate respective top channels. The cylinder comprises a partition wall extending between the two ports to form the two separate top channels.

In accordance with one method of the present invention, a method of introducing scavenged charge into a cylinder of a two-stroke internal combustion engine is provided comprising steps of providing the cylinder with an exhaust port and two pairs of transfer ports, a first one of the pairs of transfer ports being located in closer proximity to the exhaust port than a second one of the pairs of transfer ports; opening the second pair of transfer ports to a combustion chamber of the engine by a piston of the engine as the piston moves towards a bottom dead center position before the piston opens the first pair of transfer ports; and opening the first pair of transfer ports by the piston. The second pair of transfer ports is located further away from the exhaust port is opened into the combustion chamber before the first pair of transfer ports is opened into the combustion chamber.

### BRIEF DESCRIPTION OF THE DRAWINGS

The foregoing aspects and other features of the present invention are explained in the following description, taken in connection with the accompanying drawings, wherein:

FIG. 1 is a diagrammatic view of an internal combustion engine incorporating features of the present invention;

FIG. 2 is a cross sectional view of the cylinder of the engine shown in FIG. 1;

FIG. 3 is a cross sectional view of the cylinder shown in FIG. 2 taken along line 3-3;

FIG. 4 is a partial side elevational view of the side of the cylinder shown in FIG. 2 showing the exhaust port;

FIG. 5 is a diagrammatic view of a portion of an internal combustion engine comprising an alternate embodiment of the present invention;

FIG. 6 is a cross sectional view of the cylinder shown in FIG. 5 taken along line 6-6;

FIG. 7 is a cross sectional view of the cylinder shown in FIG. 5 taken along line a 7-7;

FIG. 8 is a diagrammatic view of a portion of an internal combustion engine comprising another alternate embodiment of the present invention; and

FIG. 9 is a diagrammatic view of a portion of an internal combustion engine comprising another alternate embodiment of the present invention.

### DETAILED DESCRIPTION OF THE PREFERRED EMBODIMENT

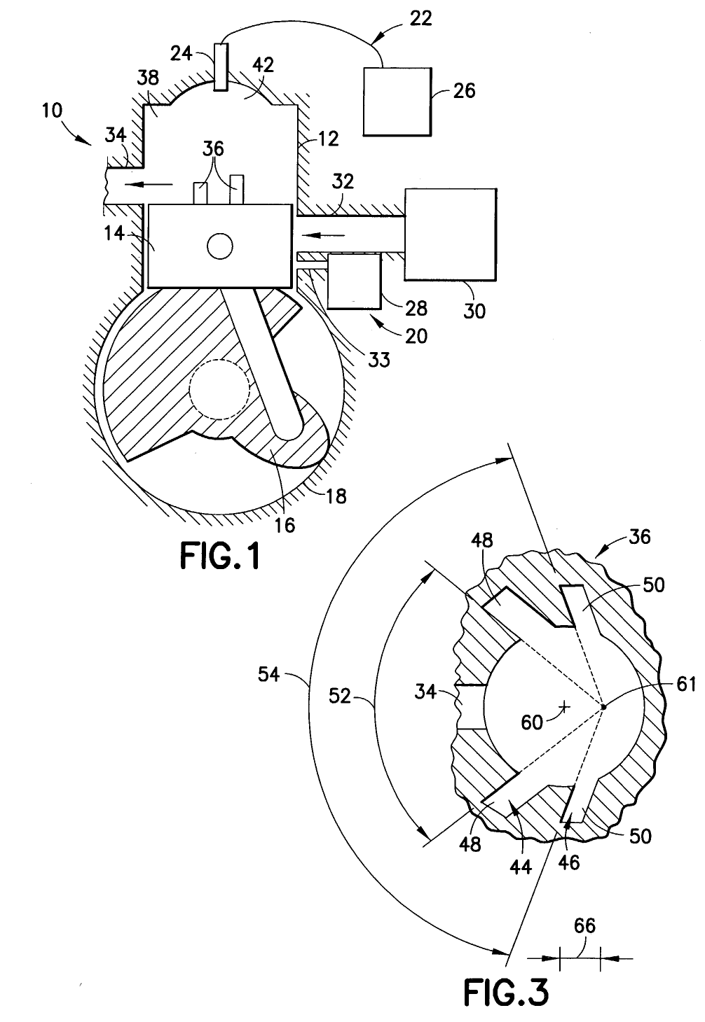

Referring to FIG. 1, there is shown a partial diagrammatic view of an internal combustion engine 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

The engine 10 is a two-stroke engine having a cylinder 12, a piston 14, a crankshaft 16, a crankcase 18, a fuel delivery system 20, and an ignition system 22. One type of specific application for the engine 10 could be in a small high speed two-stroke engine such as utilized in a hand-held power tool, such as a leaf blower, string trimmer, head trimmer, chain saw, etc.

The ignition system 22 generally comprises a spark plug 24 and an electrical generating system 26 connected to the spark plug 24. However, in alternate embodiments, any suitable type of ignition system could be used. The ignition system 22 is generally well known in the art.

The fuel delivery system 20 generally comprises a carburetor 28, an air filter 30, a main inlet 32 into the cylinder 12, and an inlet 33 into the bottom of the cylinder 12. However, in alternate embodiments, any suitable type of fuel delivery system could be used. For example, the fuel delivery system 20 could comprise a conventional fuel delivery system well known in the art. Alternatively, the fuel delivery system could comprise a fuel injection system or a newer type of efficient, fuel delivery system such as disclosed in U.S. Pat. Nos. 6,295,957; 6,293,235; 6,286,469; and 6,382,176 which are hereby incorporated by reference in their entireties.

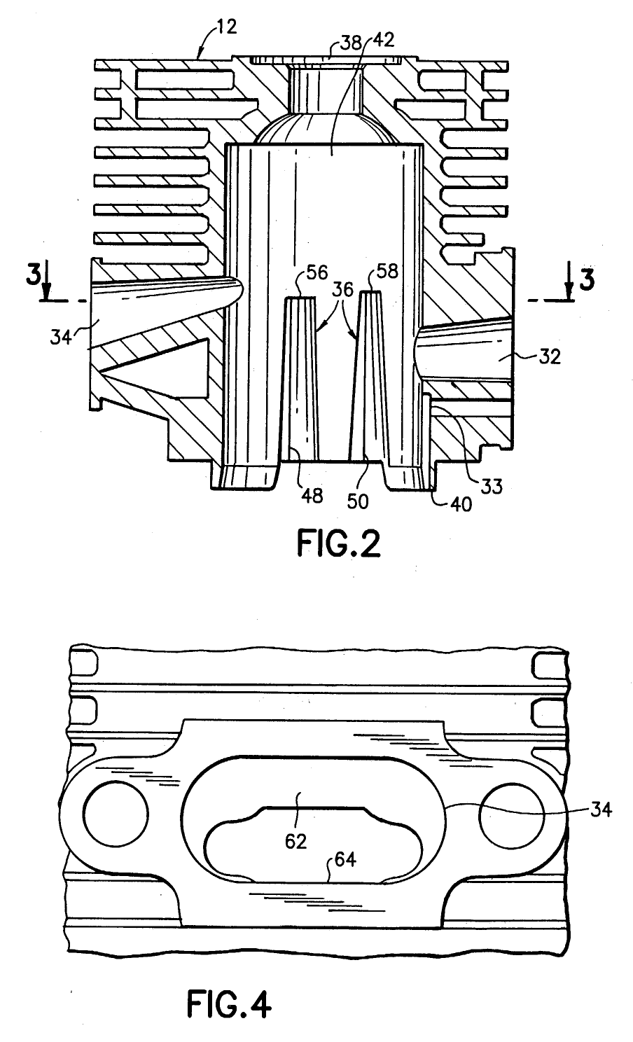

The piston 14 is movably mounted in the cylinder 12 and is operably connected to the crankshaft 16 in a conventional manner. Referring also to FIG. 2, the bottom 40 of the cylinder 12 is connected to the crankcase 18. In addition to the inlet 32, the cylinder 12 also comprises an exhaust outlet 34 and transfer ports 36. A muffler (not shown) could be attached to the exhaust outlet 34. The cylinder 12 comprises a main internal area 38 which the piston 14 reciprocally moves in, and which forms a combustion chamber 42.

Referring also to FIG. 3, in this embodiment the cylinder comprises two sets 44, 46 of the transfer ports 36. The first set of transfer ports 44 comprises a pair of first transfer ports 48. The second set of transfer ports 46 comprises a pair of second transfer ports 50. However, in alternate embodiments, the cylinder could comprise more than two sets of transfer ports, and each set of transfer ports could comprise more or less than two transfer ports each. The first set 44 of transfer ports are disposed closer to the exhaust port 34 than the second set 46 of transfer ports; which are disposed further away from the exhaust port 34.

As seen best in FIG. 3, the transfer passage walls of the transfer ports 36 are angled with respect to the cylinder axis 60 and the point of intersection 61 of the imaginary plane extending from the transfer passage walls. The first transfer ports 48 are angled relative to each other at a first angle 52. In a preferred embodiment, the first angle 52 is about 70 degrees to about 85 degrees. In one specific form of embodiment, the first angle 52 is about 79 degrees. The second transfer ports 50 are angled relative to each other at a second angle 54. In a preferred embodiment, the second angle 54 is about 120 degrees to about 150 degrees. In one specific form of embodiment, the second angle 54 is about 141 degrees.

In one type of embodiment, the main internal area 38 of the cylinder 12 has a diameter of about 1.375 in. Flows from the transfer ports 36 can be directed towards an inner most general area 61 of the intersection which is spaced at a distance 66 from the cylinder axis 60. For the diameter of about 1.375 in., the distance 66 can be about 0.3 inch to about 0.412 inch.

The transfer ports 36 are angled towards a front of the cylinder in a direction away from the exhaust port 34. The transfer ports. 36 extend upward from the bottom 40 of the cylinder to a middle section of the cylinder. The transfer ports 36 extend outward from the main internal area 38 into the interior side walls of the cylinder 12. The transfer ports 36 are preferably wider at their base, proximate the bottom 40, then at their top ends 56, 58. The top ends 56, 58 are substantially flat. However, in alternate embodiments, the top ends could have any suitable type of shape.

As seen best in FIG. 2, the top ends 56 of the first transfer ports 48 are shorter than the top ends 58 of the second transfer ports 50. The transfer ports 36 are opened and closed relative to the combustion chamber 42 as the piston 14 moves up and down in the main internal area 38 of the cylinder 12. Because of the difference in height between the top ends 56, 58 of the first and second transfer ports 48, 50, there is a differential in timing of opening of the second transfer ports 50 relative to the first transfer ports 48 as the piston moves downward in the cylinder towards its bottom dead center (BDC) position. More specifically, as the piston 14 moves downward in the cylinder 12, the second pair of transfer ports 50 are opened into the combustion chamber 42 before the first pair of transfer ports 48 are opened. As the piston 14 continues to move towards its bottom dead center position, the second pair of transfer ports 50 are subsequently opened. Because the second transfer ports 50 are located further away from the exhaust port 34 than the first transfer ports 48, the transfer ports located furthest away from the exhaust port 34 open first. The combination of the sequential opening of the different types of transfer ports and the angled shaped of the transfer ports combine to help prevent short circuiting of fresh unburned fuel from exiting the exhaust port 34.

Unlike conventional two-stroke engines, the front and rear pair of transfer ports have a phase difference in timing of their opening. As the piston moves downward towards a bottom dead center position, the piston uncovers the front ports, i.e., the second pair of ports 50 about four to eight degrees sooner than the rear ports, i.e., the first pair of transfer ports 48 are uncovered. During the early scavenging process, the front ports 50, which opened sooner, discharge live charge (fuel and air) into the cylinder, away from the exhaust port 34 due to directional discharge characteristics of the ports. The charge that is discharged furthest away from the exhaust port enters the cylinder first and, also travels the longest distance. The earliest entering charge is also the fraction of total charge that is most likely to be lost into the exhaust 34. Even though the charge that enters through the second transfer ports 50 enters first, it has to travels the farthest and is the least amount of charge entering from the two sets 44, 46. Thus, the fractional loss is also minimum.

The early opening of the front two 50 of the four transfer ports helps to establish a flow path for the charge that follows in such a way that it may result in a near-perfect displacement scavenging. Thus, flow pattern and staggered discharge of live charge helps minimize the loss of fresh fuel into the exhaust, which results in lower emissions and higher fuel economy.

The top ends 58 of the second transfer ports 50 can be located below the top end of the exhaust port 34. The width of the second transfer ports 50 can be smaller than the width of the first transfer ports 48. The use of a tapered shape along the height of the second transfer ports 50 can also reduce the size of the opening of the second transfer ports when the second transfer ports 50 are uncovered by the piston 14. It is believed that narrow opening of the front ports late during the blow-down process can increase the discharge velocity, which helps mixing. Low short circuit loss of fresh charge combined with improved mixing reduces significantly the exhaust emissions.

Referring also to FIG. 4, in the embodiment shown the exhaust port 34 comprises a general chevron shaped wall. More specifically, in the embodiment shown, the top side 62 of the exhaust port 34 has a chevron shape, has up to about 23% of total area, and the bottom side 64 has an opposite chevron shape, has about 37% of flow area. As the piston 14 uncovers the exhaust port 34 at about 118 degrees after the top dead center, the initial opening of the exhaust port 34 is relatively small, up to about 23% of the total exhaust flow area, because the apex of the upper chevron wall is merely uncovered. As the piston 14 continues to uncover more of the exhaust port 34, the opening into the exhaust port is enlarged. The chevron shaped exhaust port provides a stepped flow area which can result in optimum blow-down performance. The engine could be provided with the exhaust port feature described above alone, shown in FIG. 4, or in combination with the transfer ports as described in the embodiment. The upper chevron shape with the exhaust port timing is critical to achieve the best trapping efficiency for low emissions. It is believed that the discharge characteristics are such that the stepped flow area shortens the blow-down process without adversely affecting the trapping efficiency. It also helps a smaller area of opening during the blow-down process and traps the fresh charge better during the compression stroke. A larger exhaust flow area following the upper chevron shape, which has about 41% of total flow area, lowers the pressure difference between the crankcase and the cylinder, which increases the transfer port discharge velocity, resulting in better mixing of residual burnt gas and the fresh charge.

Tests of an engine incorporating features of the present invention has demonstrated emissions below 2004 EPA Phase II emission levels and Current CARB emission levels of HC+NOx without the use of a catalytic converter. Implementation of the present invention into a conventional engine design is relatively simple and, existing hardware (such as pistons, etc.) can be used with the redesigned cylinder described above. Tooling cost to implement the features of the present invention is minimal. The following table shows results of such a test and variations of port configurations on a 30 cc engine. Similar testing on a 25 cc engine has demonstrated low emission levels.

| | Transfer Port | Exhaust | | HC & Nox |
|---|---|---|---|---|
| | Timing In | Port Timing | | gm/hp |
| | Degrees | In Degrees | Power | hr |
| #1 cyl. | 137 (all) | 118 | 0.74 hp @ | 66.96 @ |
| Version 1 | | | 7500 rpm | 7500 rpm |
| #1 cyl. | 134, 129 | 118 | 0.90 hp @ | 53.33 @ |
| Version 2 | (staggered) | | 7500 rpm | 9000 rpm |
| #2 cyl. | 129 (all) | 118 | 0.91 hp @ | 57.90 @ |
| | | | 7500 rpm | 8500 rpm |
| #3 cyl. | 134, 129 | 118 | 0.90 hp @ | 60.85 @ |
| | (staggered) | | 7500 rpm | 8500 rpm |
| Preproduction | 134, 129 | 118 | 0.955 @ | 50.28 @ |
| cylinder | | | 8500 rpm | 8500 rpm |

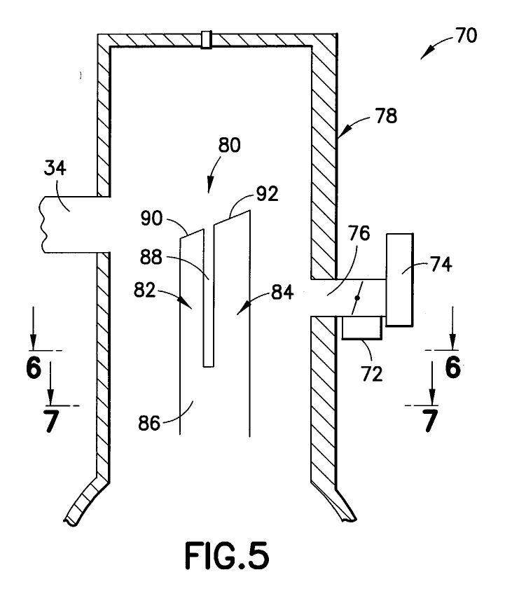

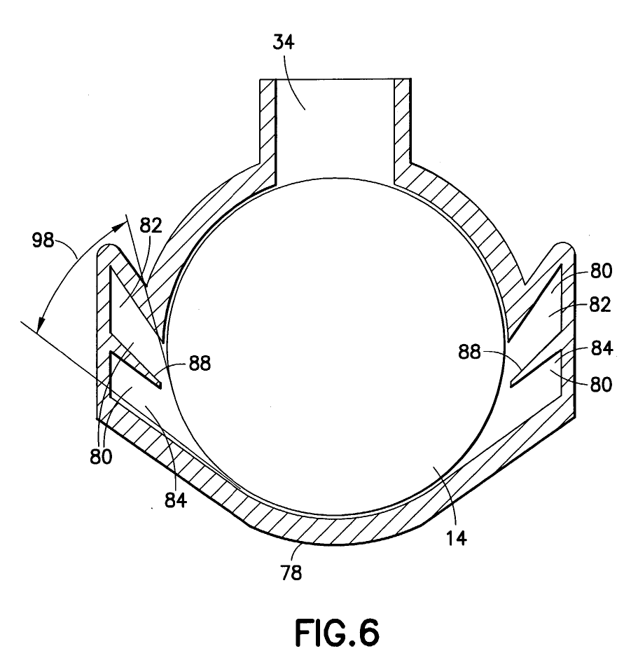

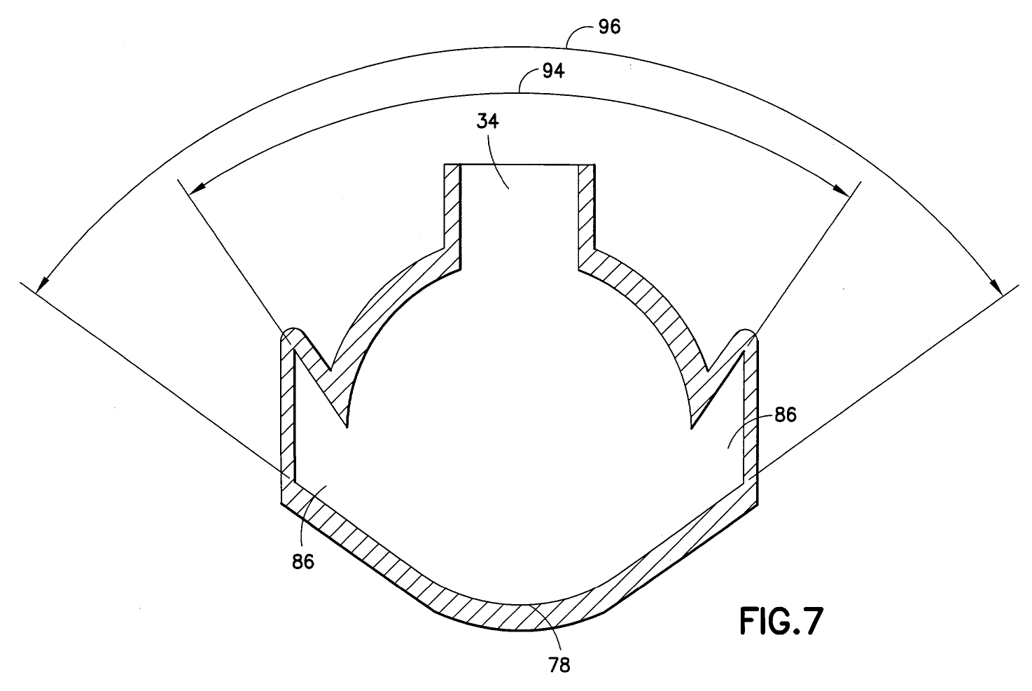

Referring now to FIGS. 5-7, an alternate embodiment of the present invention will be described. In this embodiment the engine 70 comprises a fuel delivery system 72 with an air filter 74 and an inlet 76 extending into the cylinder 78. The cylinder 78 also comprises an exhaust outlet 34 and four transfer ports 80. The transfer ports 80 comprise a first set of first transfer ports 82 and a second set of a second transfer ports 84.

Pairs of the transfer ports, on each side of the cylinder, comprise a common bottom channel 86 extending into the side wall of the cylinder in a bottom portion of the cylinder, and separate respective top channels which form two of the ports 82, 84. The cylinder 78 comprises a partition wall 88 which extends between the two ports 82, 84 to form the two separate top channels. In the embodiment shown, the partition wall 88 comprises a general triangular cross section. However, in alternate embodiments, the wall 88 could comprise any suitable cross sectional shape. The wall 88 has a height that is about two-thirds the heights of the ports 82, 84. In the embodiment shown, the forward and reward sides of the bottom channels 86 are angled relative to each other at angles 94 and 96. In one embodiment, the angle 94 is about 80 degrees and the angle 96 is about 130 degrees. However, in alternate embodiments, any suitable angles could be provided. This embodiment can be formed the same angles 52, 54—shown in the embodiment of FIG. 3. The top ends 90, 92 comprise top surfaces which are angled downward in a direction of the exhaust port 34. The second transfer ports 84 each comprise a top surface at the ends 92 which is at least partially higher than a top surface of the first transfer ports 82 at the ends 90 such that the second transfer ports open before the first transfer ports as the piston moves towards a bottom dead center position.

There is provided a progression of discharge angle 98 due to curvature of the piston. The partition walls 88 need not extend all the way to the piston 14. One of the features of this embodiment, is that the pairs of transfer ports 82, 84 can be provided in a relatively compact area. This allows features of the present invention to be used in relatively small size cylinders. In an alternate embodiment, the top ends of the transfer ports could be substantially straight and horizontal, and the top surface of the piston could be angled to allow a stepped progression of entry of a charge into the combustion chamber. In another alternate embodiment, the top surfaces of the transfer ports might not be straight, but could be non-straight.

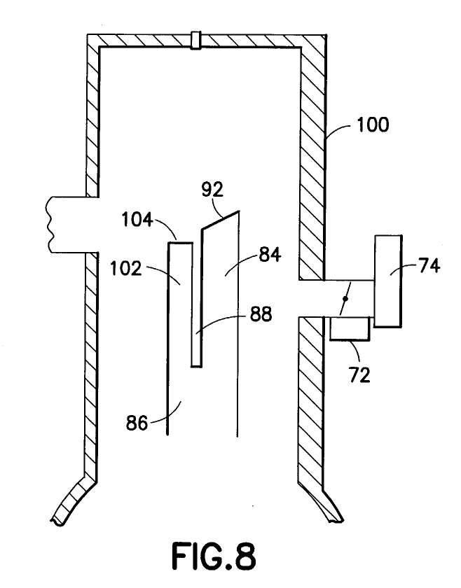

Referring now also to FIG. 8, another alternate embodiment is shown. In this embodiment the cylinder 100 comprises transfer ports with a first type of transfer ports 102 and a second type of transfer port 84. the first and second transfer ports 102, 84 comprise a common bottom channel 86. A partition wall 88 is located at a top of the bottom channel 86 and separates the two ports 102, 84 from, each other. This embodiment differs from the embodiment shown in FIG. 5 in that the top end 104 of the first transfer port 102 is substantially straight and horizontal. However, the top end 92 of the second transfer port 84 is inclined downward.

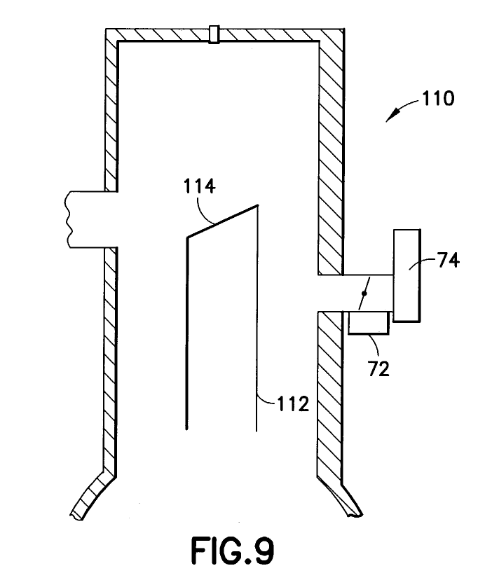

Referring now also to FIG. 9, another alternate embodiment of the present invention is shown. In this embodiment the engine 110 comprises nearly two transfer ports 112 located on opposite sides of the cylinder. Each of the transfer ports 112 comprise an angled top surface 114.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A two-stroke internal combustion engine comprising:
a cylinder; and
a piston movably mounted in the cylinder,
wherein the cylinder comprises an exhaust port and transfer ports, wherein the transfer ports comprise a first pair of the transfer ports disposed closer to the exhaust port than a second pair of the transfer ports which are disposed further away from the exhaust port, wherein the first pair of transfer ports are angled relative to each other at a first angle of about 70 degrees to about 85 degrees and the second pair of transfer ports are angled relative to each other at a second angle of about 120 degrees to about 150 degrees, wherein directional discharge of scavenged charge out of the transfer ports establishes a flow path for the scavenged charge to minimize losses of fresh unburned fuel into the exhaust port.

2. A two-stroke internal combustion engine as in claim 1 wherein the second pair of transfer ports comprise top surfaces which are at least partially higher than top surfaces of the first pair of transfer ports such that the second pair of transfer ports open before the first pair of transfer ports as the piston moves towards a bottom dead center position.

3. A two-stroke internal combustion engine as in claim 2 wherein the top surfaces of the second pair of transfer ports each comprise an inclined surface which is angled downward on a side closest to the exhaust port.

4. A two-stroke internal combustion engine as in claim 3 wherein the top surfaces of the first pair of transfer ports each comprise an inclined surface which is angled downward on a side closest to the exhaust port.

5. A two-stroke internal combustion engine as in claim 3 wherein the top surfaces of the first pair of transfer ports are not inclined towards the exhaust port.

6. A two-stroke internal combustion engine as in claim 1 wherein two of the transfer ports comprise a common bottom channel extending into a side wall of the cylinder in a bottom portion of the cylinder and separate respective top channels, wherein the cylinder comprises a partition wall extending between the two separate top channels to form the two ports.

7. A two-stroke internal combustion engine as in claim 1 wherein the exhaust port comprises a general chevron shaped top wall which has a stepped flow area.

8. A two-stroke internal combustion engine as in claim 2 wherein the exhaust port comprises a general chevron shape which has a stepped flow area.

9. A two-stroke internal combustion engine as in claim 1 wherein the first angle is about 79 degrees.

10. A two-stroke internal combustion engine as in claim 1 wherein the second angle is about 141 degrees.

11. A two-stroke internal combustion engine comprising:
a cylinder; and
a piston movably mounted in the cylinder,
wherein the cylinder comprises an exhaust port and transfer ports, wherein two of the transfer ports comprise a common bottom channel extending into a side wall of the cylinder in a bottom portion of the cylinder and separate respective top channels, wherein the cylinder comprises a partition wall extending between the two ports to form the two separate top channels.

12. A two-stroke internal combustion engine as in claim 11 wherein the transfer ports comprise a first pair of the transfer ports disposed closer to the exhaust port than a second pair of the transfer ports which are disposed further away from the exhaust port, wherein the first pair of transfer ports are angled relative to each other at a first angle of about 70 degrees to about 85 degrees and the second pair of transfer ports are angled relative to each other at a second angle of about 120 degrees to about 150 degrees, wherein directional discharge of scavenged charge out of the transfer ports establishes a flow path for the scavenged charge to minimize losses of fresh unburned fuel into the exhaust port, and wherein the two transfer ports comprise one port from each of the two pairs of transfer ports.

13. A two-stroke internal combustion engine as in claim 11 wherein a second one of the two transfer ports comprise a top surface which is at least partially higher than a top surface of a first one of the two transfer ports such that the second transfer port opens before the first transfer port as the piston moves towards a bottom dead center position.

14. A two-stroke internal combustion engine as in claim 13 wherein the top surface of the second transfer port comprises an inclined surface which is angled downward on a side closest to the exhaust port.

15. A two-stroke internal combustion engine as in claim 14 wherein the top surface of the first transfer port comprises an inclined surface which is angled downward on a side closest to the exhaust port.

16. A two-stroke internal combustion engine as in claim 14 wherein the top surface of the first transfer port is not inclined towards the exhaust port.

17. A two-stroke internal combustion engine as in claim 11 wherein the exhaust port comprises a general chevron shaped top wall which has a stepped flow area.

18. A method of introducing scavenged charge into a cylinder of a two-stroke internal combustion engine, the method comprising steps of:
providing the cylinder with an exhaust port and two pairs of transfer ports, a first one of the pairs of transfer ports being located in closer proximity to the exhaust port than a second one of the pairs of transfer ports;
opening the second pair of transfer ports to a combustion chamber of the engine by a piston of the engine as the piston moves towards a bottom dead center position before the piston opens the first pair of transfer ports; and
opening the first pair of transfer ports by the piston,
wherein the second pair of transfer ports located further away from the exhaust port is opened into the combustion chamber before the first pair of transfer ports is opened into the combustion chamber.

19. A method as in claim 18 wherein the step of providing the cylinder comprises providing the first pair of transfer ports with an angle relative to each other of about 70 degrees to about 85 degrees and the second pair of transfer ports with an angle relative to each other of about 120 degrees to about 150 degrees.

20. A method as in claim 18 wherein the step of providing the cylinder comprises providing the second pair of transfer ports with top surfaces which are inclined downward in a direction towards the exhaust port.

21. A method as in claim 17 wherein the first step in the chevron shape of the exhaust port is about 22% of the total exhaust flow area, wherein the top edge of the chevron shape opens at about 118 degrees after top dead center, where in the second larger area is only about 41% of the total area, and where in the lower chevron shape constitutes about 37% of the total flow area.
